(19) United States
(12) Patent Application Publication
(10) Pub. No.: US 2012/0159234 A1
(43) Pub. Date: Jun. 21, 2012

(54) PROVIDING RESILIENT SERVICES

(75) Inventors: Bimal Kumar Mehta, Sammamish, WA (US); Vijay Kishen Hampapur Parthasarathy, Sammamish, WA (US); Sankaran Narayanan, Redmond, WA (US); Erdinc Basci, Redmond, WA (US)

(73) Assignee: Microsoft Corporation, Redmond, WA (US)

(21) Appl. No.: 12/969,405

(22) Filed: Dec. 15, 2010

(51) Int. Cl. G06F 11/20

(52) U.S. Cl. 714/4.11; 714/E11.073

(57) ABSTRACT

Described are embodiments directed at providing resilient services using architectures that have a number of failover features including the ability to handle failover of an entire data center. Embodiments include a first server pool at a first data center that provides client communication services. The first server pool is backed up by a second server pool that is located in a different data center. Additionally, the first server pool serves as a backup for the second server pool. The two server pools thus engage in replication of user information that allows each of them to serve as a backup for the other. In the event that one of the data centers fails, requests are rerouted to the backup server pool.

### BACKGROUND

It is becoming more common for information and software applications to be stored in the cloud and provided to users as a service. One example in which this is becoming common is in communications services, which include instant messaging, presence, collaborative applications, voice over IP (VoIP), and other types of unified communication applications. As a result of the growing reliance on cloud computing, the services provided to users must be resilient, i.e., provide reliable failover systems, so that users will not be affected by outages that may affect servers hosting applications or information for users.

The cloud computing architectures that are used to provide cloud services should therefore be able to handle failure on a number of levels. For example, if a single server hosting IM or conference services fails, the architecture should be able to provide a failover for the failed server. As another example, if an entire data center with a large number of servers hosting different services fails, the architecture should also be able to provide adequate failover for the entire data center.

It is with respect to these and other considerations that embodiments of the present invention have been made. Also, although relatively specific problems have been discussed, it should be understood that embodiments of the present invention should not be limited to solving the specific problems identified in the background.

### SUMMARY

This summary is provided to introduce a selection of concepts in a simplified form that are further described below in the Detail Description section. This summary is not intended to identify key features or essential features of the claimed subject matter, nor is it intended to be used as an aid in determining the scope of the claimed subject matter.

Described are embodiments directed to providing resilient services using architectures that have a number of failover features including the ability to handle failover of an entire data center. Embodiments include a first server pool at a first data center that provides client communication services that may include instant messaging, presence applications, collaborative applications, voice over IP (VoIP) applications, and unified communication applications to a number of clients. The first server pool is backed up by a second server pool that is located in a different data center. Additionally, the first server pool serves as a backup for the second server pool. The two server pools thus engage in replication of user information that allows each of them to serve as a backup for the other. In the event that one of the data centers fails, requests are rerouted to the backup server pool.

Embodiments may be implemented as a computer process, a computing system or as an article of manufacture such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process.

### BRIEF DESCRIPTION OF THE DRAWINGS

Non-limiting and non-exhaustive embodiments are described with reference to the following figures.

FIG. 1 illustrates an embodiment of a system that may be used to implement embodiments.

FIG. 2 illustrates a block diagram of a two server pools that may be used in some embodiments.

FIG. 3 illustrates an operational flow providing backup features for a server pool consistent with some embodiments.

FIG. 4 illustrates an operational flow for replicating information between server pools consistent with some embodiments.

FIG. 5 illustrates an operational flow for rerouting requests directed to an inoperable server pool consistent with some embodiments.

FIG. 6 illustrates a block diagram of a computing environment suitable for implementing embodiments.

### DETAILED DESCRIPTION

Various embodiments are described more fully below with reference to the accompanying drawings, which form a part hereof, and which show specific exemplary embodiments for practicing the invention. However, embodiments may be implemented in many different forms and should not be construed as limited to the embodiments set forth herein; rather, these embodiments are provided so that this disclosure will be thorough and complete, and will fully convey the scope of the invention to those skilled in the art. Embodiments may be practiced as methods, systems or devices. Accordingly, embodiments may take the form of a hardware implementation, an entirely software implementation or an implementation combining software and hardware aspects. The following detailed description is, therefore, not to be taken in a limiting sense.

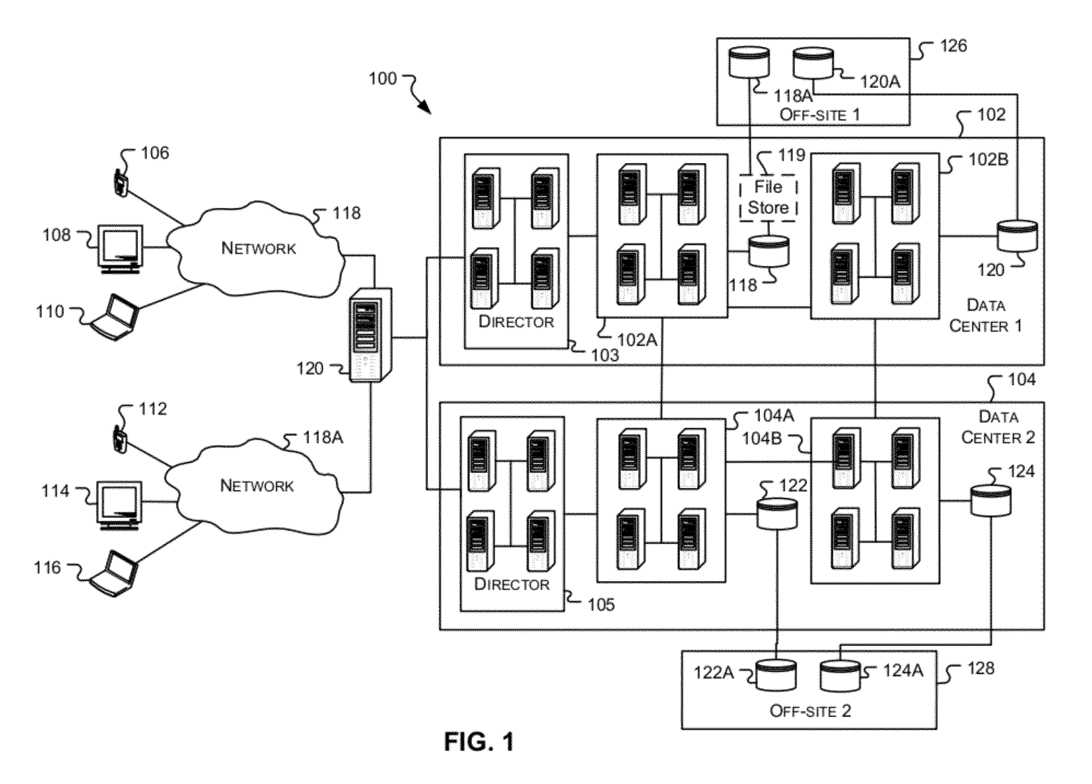

FIG. 1 illustrates a system 100 that may be used to implement embodiments. Generally, system 100 includes components that are used in providing communication services to clients from the cloud. As described in greater detail below, system 100 implements an architecture that allows the communication services to be resilient despite failure, or unavailability, of portions of the system. System 100 provides a reliable service to clients utilizing the communication services.

FIG. 1 illustrates a first data center 102 and a second data center 104. Each of the data centers 102 and 104 include multiple server pools (102A, 102B, 104A, and 104B) that are used to provide communication services to a number of users on clients (106, 108, 110, 112, 114, and 116) including instant messaging, presence applications, collaborative applications, voice over IP (VoIP) applications, and unified communication applications. Each of the server pools (102A, 102B, 104A, and 104B) include a number of servers, for example in a server cluster. The server pools (102A, 102B, 104A, and 104B) provide the communication services to the users of clients (106, 108, 110, 112, 114, and 116). For example, a user using client 106, a smartphone device, may request to start an instant messaging session. The request may be transmitted through a network 118 to an intermediate server 120 which routes the request to one of data centers 102 or 104 depending on the particular server pool which is associated for handling requests from the user. For purposes of illustration, administrative server 120 may direct the request to server pool 102A. At least one of the servers in server pool 102A hosts the instant messaging application that is used to provide the instant messaging service to the user on client 106.

As shown in FIG. 1, each of the server pools also communicates with a backend database (118, 120, 122, and 124). The backend databases 118, 120, 122, and 124 store user information that is persisted. For example, in some embodiments, databases 118, 120, 122, and 124 may store information about contacts of a particular user or other user information that is persisted. It should be noted that although the FIG. 1 and the description describe databases 118, 120, 122, and 124, in some embodiments, information may be stored in a file store instead of in databases. In yet other embodiments, as shown in FIG. 1 information may be stored in both a database and a file share in a file store such as file store 119. For example, presence information and contact lists may be stored in database 118 and some user conference content data may be stored in a file share in file store 119. Thus, although the description below is with respect to databases 118, 120, 122, and 124, the embodiments are not limited to databases.

System 100 includes various features that allow server pools (102A, 102B, 104A, and 104B) to provide resilience services when components of system 100 are inoperable. The inoperability may be caused by on routine maintenance performed by an administrator, such as for example the addition of new servers to a server pool or upgrading of hardware or software within system 100. In other cases the inoperability may be caused by the failure of one or more components within system 100. As described in greater detail below, system 100 includes a number of backups that provide resilient services to users on clients (106, 108, 110, 112, 114, and 116).

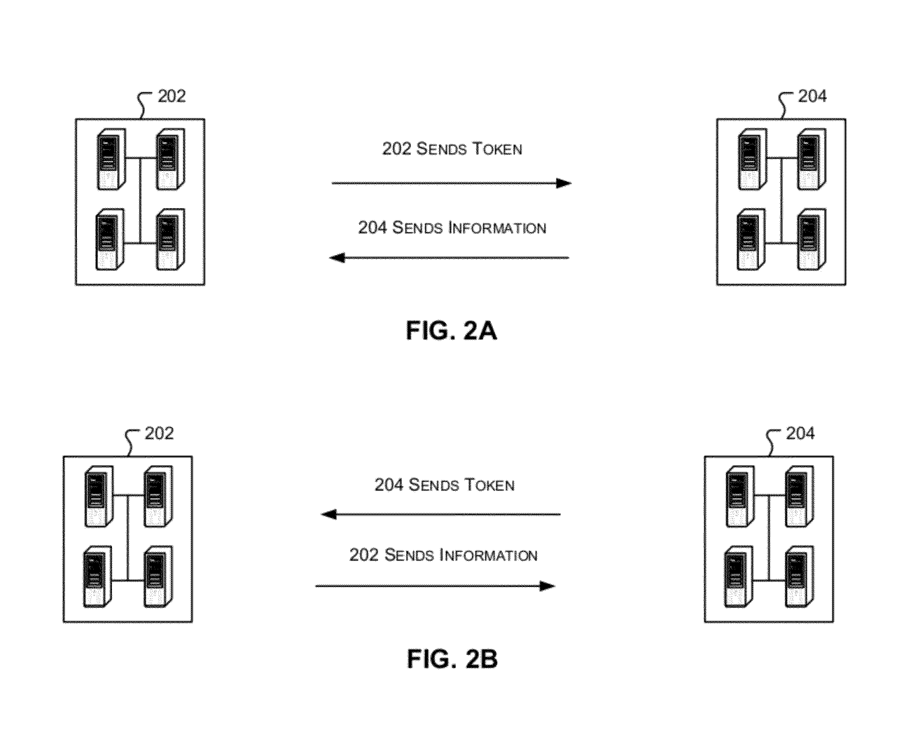

One feature that provides resiliency within system 100 is the topology configuration of the server pools within system 100. The topology is configured so that a server pool in data center 102 is backed up by a server pool located in data center 104. For example, server pool 102A within data center 102, is configured to be backed up by server pool 104A in data center 104. In addition, server pool 104A uses server 102A as a backup for user information on server 104A. Accordingly, at regular intervals server pool 102A and server pool 104A engage in a mutual replication to exchange information so that each contains up to date user information from the other. This allows server pool 102A to be used to service requests directed to server pool 104A should server pool 104A become inoperable. Similarly, server pool 104A is used to service requests directed to server pool 102A should server pool 102A become inoperable. An embodiment of mutual replication is illustrated in FIGS. 2A and 2B described below.

As indicated above, server pool 102A is in data center 102 which is different than the data center of its backup, namely server pool 104A, which is in data center 104. In embodiments, data center 102 is located in a different geographical location than data center 104. This provides an additional level of resiliency. As those with skill in the art will appreciate, locating a backup server pool in a different geographical location reduces the likelihood that the backup server pool will be unavailable at the same time as the primary server pool. For example, data center 102 may be located in California while data center 104 may be located in Colorado. If for some reason there is a power outage that affects data center 102 it is located far enough away from data center 104 that it is unlikely that the same issues will affect data center 104. As those with skill in the art will appreciate, even if data center 102 and data center 104 are not separated by long distances, such as located in different states, having them in different locations reduces the risk that they will be unavailable at the same time. The data centers in embodiments are further designed be connected by a relatively large bandwidth and stable connection.

In some embodiments, each data center 102 and 104 may include a specially configured server pool referred to herein as a director pool. In the embodiment shown in FIG. 1, server pool 103 is the director pool for data center 102 and server pool 105 is the director pool for data center 104. The director pools 103 and 105 are configured in embodiments to allow them to act as intermediaries for rerouting requests for server pools that are inoperable within their respective data centers. For example, if server pool 102B is inoperable, for example because of routine maintenance being performed on server pool 102B, director pool 103 will determine that server pool 102B is inoperable and will redirect any requests directed at server pool 102B to server pool 104B in data center 104. Because of the additional functions performed by director server pools 103 and 105, they are provided with additional resources. The director server pools store routing related data for the user. The data in embodiments comes from a directory service. This information is the same and is available in all director pools in the deployment.

There may be various ways in which a director server pool in a data center determines whether a server pool is inoperable. One way may be for each server pool within a data center to send out a periodic heartbeat message. If a long period of time has passed since a heartbeat messages has been received from a server pool, then it may be considered inoperable. In some embodiments, the determination that a pool is down is not made by the director server pool but rather requires a quorum of pools within a data center to decide that a server pool is inoperable and that requests to that pool should be rerouted to its backup.

Additional resilience is provided by the backup of databases (118, 120, 122, and 124). As shown in FIG. 1, database 118 has a backup 118A and database 120 has a backup 120A, which are located at an off-site location 126 from data center 102. By off-site location it is meant a location different than the data center. The off-site location may be in a different building or a different geographical location. As shown in FIG. 1, database 122 as a backup 122A located in an off-site location 128. Similarly, database 124 has a backup 124A located in the off-site location 128. In other embodiments, the backup databases 118A, 120A, 122A, and 124A are not located offsite but are located in the same data center as the primary database. They will be utilized if their respective primary database fails.

In embodiments, the backup databases (118A, 120A, 122A, and 124A) mirror their respective databases and therefore can be used in situations in which databases (118, 120, 122, and 124) are inoperable because of routine maintenance or because of some failure. If any of the databases (118, 120, 122, and 124) fail, server pools (102A, 102B, 104A, and 104B) access the respective backup databases (118A, 120A, 122A, and 124A) to retrieve any necessary information.

As indicated above, system 100 provides a resilient communication services to users on clients (106, 108, 110, 112, 114, and 116). As one example, a user on client 114 may request to be part of an audio/video conference that is being provided through system 100. The user would send a request through network 118A to log into the conference. The request would be transmitted to intermediate server 120 which may include logic for load-balancing between data centers 102 and 104. In this example, the request is transmitted to director server pool 105. The director server pool 105 may determine that server pool 104B should handle the request.

Server pool 104B includes a server that provides services for the user to participate in the audio/video conference. If the server providing the audio/video conference services fails, then server pool 104B can failover to another server within server pool 104B. This provides a level of resiliency. This failover occurs automatically and transparent to the user. Also, the failure may create some interruption as the client used by the user re-joins the conference but there will not be any loss of data. In other embodiments, the user may not see any interruption in the audio/video conference service.

As shown in FIG. 1, server pool 104B is backed up by server pool 102B. Therefore, user's presence, conference content data, or any other data generated/owned by the user is replicated to server pool 102B based on the predetermined replication schedule. If there should be a failure of data center 104 (e.g., a power outage), server pool 104B would also fail, however the audio/video conference service would failover to server pool 102B. This failover would occur automatically and the user using client device 114 would see no interruption in the audio/video conference. In some embodiments, the failover may create some interruption as the client used by the user re-joins the conference but there will not be any loss of data.

As this example illustrates, system 100 provides a number of features that allow services to be provided to users without interruption even if there are a number of components that are unavailable within system 100. As those with skill in the art will appreciate, the example above is not intended to be limiting and is provided only for purposes of description. Any type of communication service, such as instant messaging, presence applications, collaborative applications, VoIP applications, and unified communication applications may be provided as a resilient service using system 100.

Embodiments of system 100 provide a number of availability and recovery features that are useful for users of the system 100. For example, in a disaster recovery scenario, i.e., a pool or entire data center fails, any requests for data are re-routed to the backup pool/data center and service occurs uninterrupted. Also, embodiments of system 100 provide for high availability. For example, if a server in a pool is unavailable because of a large number of requests or a failure, other servers in the pool start handling the requests also the backup (e.g., mirrored) databases become active in servicing requests.

FIGS. 2A and 2B illustrates a block diagram of two server pools 202 and 204 that engage in a mutual replication. Server pools 202 and 204 in embodiments may be implemented as anyone of server pools 102A, 102B, 104A, and 104B described above with respect to FIG. 1.

As shown in FIG. 2A, server pool 202 sends a token to server pool 204. The token may be in any format but includes information that indicates a last change that server pool 202 received. The indication maybe in the form of sequence numbers, timestamps, or other unique values that allow server pool 204 to determine the last change received by server pool 202. In response to receiving the token, sever pool 204 will send any changes that have been made on server pool 204 since the last change received by server pool 202.

As noted above, in embodiments, server pool 202 serves as a backup to server pool 204 and vice versa (i.e., server pool 204 serves as a backup to server pool 202). As a result, as shown in FIG. 2B server pool 204 will send a token to server 202 indicating a last change it received from server pool 202. In response to receiving the token, sever pool 202 will send any changes that have been made on server pool 202 since the last change received by server pool 204.

As those with skill in the art will appreciate, the information that is replicated between server 202 and 204 is any information that is necessary for the server pools to serve as backups in providing communication services. For example, the information that is exchanged during the mutual replication may include user's contact information, user's permission information, conferencing data, and conferencing metadata.

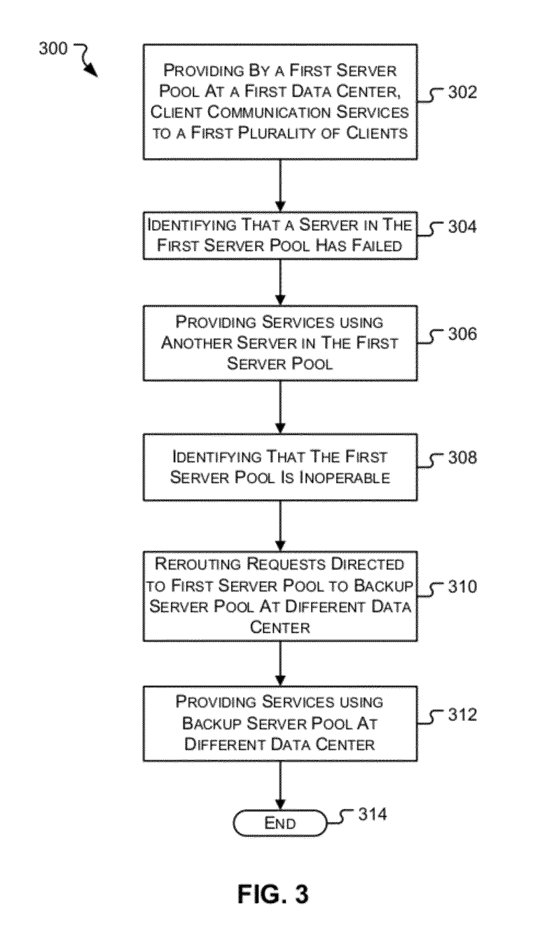

FIGS. 3, 4, and 5 illustrate operational flows 300, 400, and 500 according to embodiments. Operational flows 300, 400, and 500 may be performed in any suitable computing environment. For example, the operational flows may be executed by systems such as illustrated in FIGS. 1 and 2. Therefore, the description of operational flows 300, 400, and 500 may refer to at least one of the components of FIGS. 1 and 2. However, any such reference to components of FIGS. 1 and 2 is for descriptive purposes only, and it is to be understood that the implementations of FIGS. 1 and 2 are non-limiting environments for operational flows 300, 400, and 500.

Furthermore, although operational flows 300, 400, and 500 are illustrated and described sequentially in a particular order, in other embodiments, the operations may be performed in different orders, multiple times, and/or in parallel. Further, one or more operations may be omitted or combined in some embodiments.

Operational flow 300 begins at operation 302 where a first server pool provides client communication services to a first plurality of clients. In embodiments, the first server pool is in a first data center such as server pools 102A and 102B (FIG. 1) described above. The first plurality of clients may be any type of client that is utilized by a user to receive communication services. For example, the clients may be laptop computers, desktop computers, smart phone devices, or tablet computers some of which are shown as clients 106, 108, 110, 112, 114, and 116 (FIG. 1). In embodiments, the particular communication services are any type of communication or collaborative services including without limitation instant messaging, presence applications, collaborative applications, VoIP applications, and unified communication applications.

In some embodiments, the communication services provided to the plurality of clients may be preceded by the establishment of a session with each of the plurality of clients. In one embodiment, the session initiation protocol (SIP) is used in establishing the session. As those with skill in the art will appreciate, use of SIP allows for more easily implementing failover mechanisms to provide resilient services to clients. That is, when a client sends a request to a particular server pool, if the server pool is unavailable, information may be provided to the client to reroute its future requests to a backup server pool.

After operation 302, an identification is made at operation 304 that a server in the first server pool has failed. In embodiments, the server that has failed is actively providing services to clients.

The first server pool includes a plurality of servers each of which may act as a failover to carry the load of the failed server. This provides a level of resiliency that allows the services being provided to the plurality of clients to continue without interruption despite a server in the first server pool having failed. Accordingly, at operation 306 services were being provided by the failed server are provided using another server in the first server pool.

At a later point in time, flow passes to operation 308 where the first server pool is identified as inoperable. This operation may be performed in some embodiments by a director server pool, or some other administrative application that manages the first data center. The inoperability may be based on some type of failure (e.g., hardware failure, software failure, or even complete failure of the first data center) of the first server pool. In other embodiments, the inoperability may be merely an administrative event for example updating software or hardware within the first server pool.

After operation 308 flow passes to operation 310 where requests are rerouted to the backup server pool configured to back up the first server pool. In embodiments, the backup server pool is located at a different data center that may be at a geographically distant location from the first data center. The location of the different data center provides an additional level of resiliency that makes it unlikely that the backup server pool will be unavailable when the first server pool is unavailable.

After operation 310, flow passes to operation 312 where the backup server pool is used to provide services to the plurality of clients. Operations 310 and 312 in embodiments occur automatically and transparently to the plurality of clients. In this way, the services being provided to the clients are provided without interruption and are resilient to a server failure and also a complete data center failure. Flow 300 ends at 314.

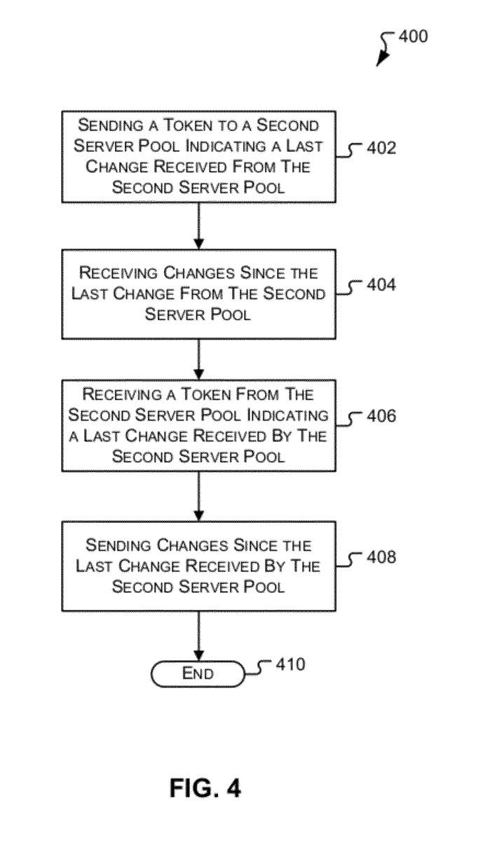

Flow 400 shown in FIG. 4, illustrates a process by which a first server pool engages in a mutual replication with a second server pool. The server pools may be in embodiments, implemented as server pools 102A, 102B, 104A, and 104B described above with respect to FIG. 1. Flow 400 begins at operation 402 where a token is sent from the first server pool to a second server pool. The token includes an indication of the last change received from the second server pool in a previous replication. Flow 400 then passes from operation 402 to operation 404 where changes are received from the second server pool. The information received at operation 404 reflects any changes that have been made since the last change received from the second server pool in the previous replication with the second server pool.

As part of the mutual authentication, flow passes to operation 406 where the first server pool will receive a token from the second server pool indicating a last change received by the second server pool. In response, the first server pool will determine what changes must be sent to the second server pool to ensure that the second server pool includes the necessary information should it have to act in a failover capacity. At operation 408 any changes that have been made on the first server pool are sent to the second server pool. Flow 400 ends at 410.

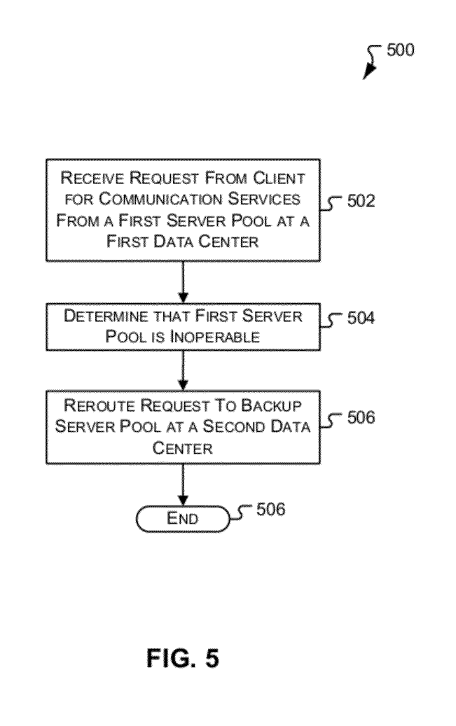

Referring now to FIG. 5, flow 500 describes a process that may be implemented by a director server pool as a result of a server pool being inoperable. Flow 500 begins at operation 502 where a request is received from a client for communication services from a first server pool at a first data center. Following operation 502 a determination is made at operation 504 that the first server pool is inoperable. There may be various ways in which the determination at operation 504 is made. One way may be that the first server pool has not sent out a periodic heartbeat message for a long period of time. In other embodiments, the determination may be based on previous requests sent to the first data pool that have not been acknowledged.

After operation 504, flow 500 passes to operation 506 where the request is rerouted to a backup server pool at a second data center. In embodiments, the second data center is located at a different geographic location as the first server pool to reduce the risk that the backup server pool is unavailable. Flow end at 508.

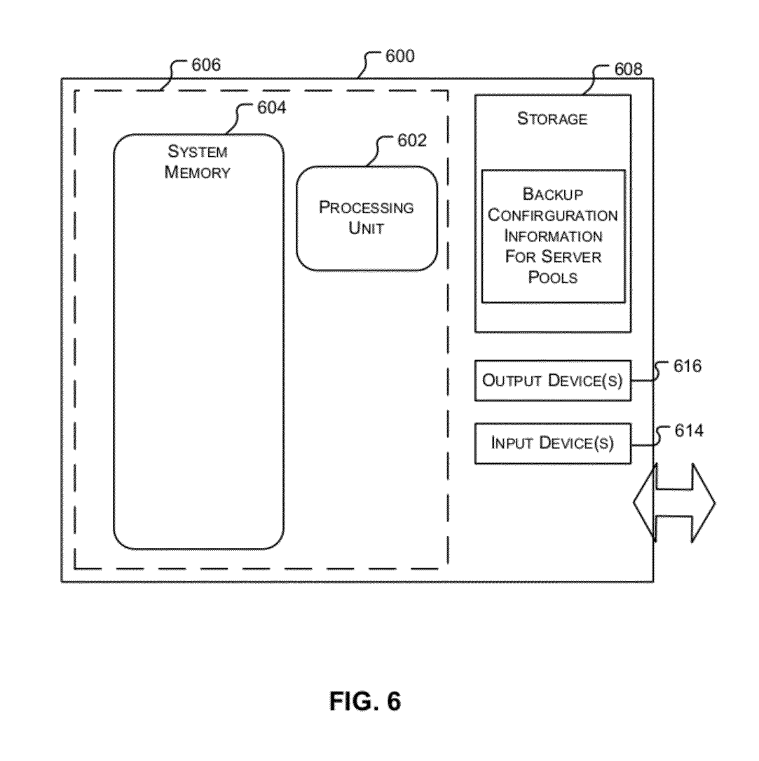

FIG. 6 illustrates a general computer system 600, which can be used to implement the embodiments described herein. The computer system 600 is only one example of a computing environment and is not intended to suggest any limitation as to the scope of use or functionality of the computer and network architectures. Neither should the computer system 600 be interpreted as having any dependency or requirement relating to any one or combination of components illustrated in the example computer system 600. In embodiments, system 600 may be used as a client and/or server described above with respect to FIGS. 1 and 2.

In its most basic configuration, system 600 typically includes at least one processing unit 602 and memory 604. Depending on the exact configuration and type of computing device, memory 604 may be volatile (such as RAM), non-volatile (such as ROM, flash memory, etc.) or some combination of the two. This most basic configuration is illustrated in FIG. 6 by dashed line 606. System memory 604 stores applications that are executing on system 600. For example, memory 604 may store configuration information for determining the backups for server pools. Memory 604 may also include the in memory location 620 where edited metadata is stored for executing a preview of an edited report.

The term computer readable media as used herein may include computer storage media. Computer storage media may include volatile and nonvolatile, removable and non-removable media implemented in any method or technology for storage of information, such as computer readable instructions, data structures, program modules, or other data. System memory 604, removable storage, and non-removable storage 608 are all computer storage media examples (i.e. memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 600. Any such computer storage media may be part of device 600. Computing device 600 may also have input device(s) 614 such as a keyboard, a mouse, a pen, a sound input device, a touch input device, etc. Output device(s) 616 such as a display, speakers, a printer, etc. may also be included. The aforementioned devices are examples and others may be used.

The term computer readable media as used herein may also include communication media. Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

Reference has been made throughout this specification to “one embodiment” or “an embodiment,” meaning that a particular described feature, structure, or characteristic is included in at least one embodiment. Thus, usage of such phrases may refer to more than just one embodiment. Furthermore, the described features, structures, or characteristics may be combined in any suitable manner in one or more embodiments.

One skilled in the relevant art may recognize, however, that the invention may be practiced without one or more of the specific details, or with other methods, resources, materials, etc. In other instances, well known structures, resources, or operations have not been shown or described in detail merely to avoid obscuring aspects of the invention.

While example embodiments and applications have been illustrated and described, it is to be understood that the invention is not limited to the precise configuration and resources described above. Various modifications, changes, and variations apparent to those skilled in the art may be made in the arrangement, operation, and details of the methods and systems disclosed herein without departing from the scope of the claimed invention.

We claim:

1. A computer implemented method of providing a transparent failover for client services, the method comprising:
identifying that a first server pool that provides client communication services to a plurality of clients is inoperable, wherein the first server pool is located at a first data center;
in response to identifying that the first server pool is inoperable, rerouting requests directed to the first server pool to a second server pool located at a second data center different from the first data center; and
providing the client communication services to the plurality of clients using the second server pool.

2. The method of claim 1, wherein the first server cluster accesses client information from a first a database located at the first data center.

3. The method of claim 2, wherein a second database provides a backup for the first database and is located within the first data center.

4. The method of claim 1, wherein prior to the identifying that the first server pool has failed, replicating information from the first server pool to the second server pool.

5. The method of claim 4, wherein the replicating comprises:
the first server pool receiving a token from the second server pool, the token indicating a last change received by the second server pool; and
the first server pool sending any information to the second server pool that has changed since the last change received by the second server pool.

6. The method of claim 5, wherein the replicating further comprises:
the second sending a second token to the first server pool, the second token indicating a last change received by the first server pool; and receiving any information that has changed since the last change received by the first server pool.

7. The method of claim 1, wherein the second server pool provides client communication services to a second plurality of clients different from the first plurality of clients.

8. The method of claim 1, wherein the identifying, rerouting, and providing are performed automatically.

9. The method of claim 1, wherein the first server pool is inoperable as a result of an administrative action.

10. The method of claim 1, wherein the first server pool is inoperable as a result of a failure of the first data center.

11. A computer readable storage medium comprising computer executable instructions that when executed by a processor perform a method of providing backup client communication services, the method comprising:
providing client communication services to a plurality of clients with a first plurality of servers in a first server pool located at a first data center;
identifying that a first server of the first plurality of servers has failed;
providing services previously provided by the first server of the first plurality of servers with a different one of the first plurality of servers;
identifying that the first server pool has failed;
in response to identifying that the first server pool has failed, rerouting requests directed to the first server pool to a second plurality of servers in a second server pool located at a second data center different from the first data center; and
providing the client communication services to the plurality of clients with the second plurality of servers in a second server pool.

12. The computer readable storage medium of claim 11, wherein the method further comprises establishing a session with a client using a session initiation protocol (SIP) for providing the client services.

13. The computer readable storage medium of claim 12, wherein the client communications services comprise one or more of presence services, conferencing services instant messaging, and voice services.

14. The computer readable storage medium of claim 11, wherein the method further comprises, prior to the identifying that the first server pool has failed, replicating information from the first server pool to the second server pool.

15. The computer readable storage medium of claim 11, wherein failure of the first server pool is caused by a failure of the first data center.

16. The computer readable storage medium of claim 11, wherein the second server pool provides client communication services to a second plurality of clients different from the first plurality of clients.

17. A computer system for providing client communication services, the system comprising:
a first plurality of servers in a first server pool providing client communication services to a first plurality of clients and located a first data center, wherein the first plurality of servers are configured to:
in response to an identification of a first server in the first plurality of servers having failed, provide services previously provided by the first server of the first plurality of servers with a different one of the first plurality of servers;
send a token indicating a last change received by the first server pool from a second server pool located at a second data center;
receive any information from the second server pool that has changed since the last change received by the first server pool; and
provide the client communication services to a second plurality of clients when the second server pool fails, the second plurality of clients different from the first plurality of clients.

18. The system of claim 17, further comprising a first database located at the first data center and used by the first plurality of servers to store information associated with users of the first plurality of clients.

19. The system of claim 18, a second database provides a backup for the first database and is located within the first data center.

20. The system of claim 17, wherein failure of the second server pool is caused by a failure of the second data center.
